(19) United States
(12) Patent Application Publication
(10) Pub. No.: US 2004/0199890 A1
(43) Pub. Date: Oct. 7, 2004

(54) Semiconductor integrated circuit device and manufacturing method thereof

(76) Inventor: Masahiro Segami, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/805,284

(22) Filed: Mar. 22, 2004

(30) Foreign Application Priority Data
Apr. 3, 2003 (JP) P2003-100751

(51) Int. Cl. G06F 9/45

(52) U.S. Cl. 716/7

(57) ABSTRACT

A method of manufacturing a semiconductor integrated circuit device having a plurality of chips mounted thereon, the semiconductor integrated circuit device being fabricated as a package. This manufacturing method comprises a process for mounting a plurality of chips containing a chip 101 including a characteristic adjustment means 7 and a chip 102 which does not include the characteristic adjustment means 7 and fabricating these chips as a package to form a semiconductor integrated circuit device 1 and a succeeding process for adjusting a characteristic of the chip 101 including the characteristic adjustment means 7 and a characteristic of the chip 102 which does not include the characteristic adjustment means 7 by using the characteristic adjustment means 7. A method of manufacturing a semiconductor integrated circuit device according to the present invention can make an analog characteristic become high in accuracy as a product specification and which can reduce a time required by an inspection process.

### BACKGROUND OF THE INVENTION

1. Field of the Invention

The present invention relates to a semiconductor integrated circuit device and a manufacturing method thereof.

2. Description of the Related Art

As semiconductor integrated circuit devices, there is widely used such a semiconductor integrated circuit device that incorporates therein a trimming circuit in order to effect such suitable operations as to set function/operation parameters of an electronic circuit and to trim (fine adjust) an output voltage from a reference voltage generating circuit.

FIG. 1 of the accompanying drawings shows an arrangement of a semiconductor integrated circuit device incorporating therein such a trimming circuit. Especially, FIG. 1 shows a circuit arrangement of a chip comprising a semiconductor integrated circuit device.

A semiconductor integrated circuit device, generally depicted by the reference numeral 30 in FIG. 1, includes a chip (IC chip) 301 to output an analog signal based upon a digital signal inputted from the outside. Although not shown, this chip 301 is mounted on a substrate and this substrate with this chip 301 mounted thereon is fabricated as a package to form the semiconductor integrated circuit device 30.

As shown in FIG. 1, the chip 301 is composed of a digital circuit 32, a first analog circuit 33, a communication means (serial communication means) 34, a memory means 35 and an analog adjustment means 36.

The digital circuit 32 processes digital data inputted from the outside to output a digital signal, and the first analog circuit 33 converts a digital signal inputted from the digital circuit 32 to provide an analog signal by a suitable means such as a D/A (digital-to-analog) converter.

The serial communication means 34 controls the memory means 35 to write therein information and also controls the memory means 35 to be disconnected based upon information (data) or a command inputted from the outside. The serial communication means 34 is controlled based upon a serial protocol such as an I²C (Inter-Integrated Circuit).

The memory means 35 holds information outputted from the aforementioned serial communication means 34 and is composed of a zapping zener diode or a fuse-element of the type to be disconnected by laser beams.

The analog adjustment means 36 generates a signal to adjust the first analog circuit 33 based upon information inputted from the aforementioned memory means 35.

In the chip 301 having such arrangement, the serial communication means 34, the memory means 35 and the analog adjustment means 36 constitute a characteristic adjustment means 37 (so-called trimming circuit). In the process (inspection process) for adjusting characteristics in the manufacturing process, for example, this characteristic adjustment means 37 trims the characteristic of the first analog circuit 33.

[Cited Patent Reference 1]

Japanese laid-open patent application 8-204582

While one semiconductor integrated circuit device 30 is composed of the single chip 301 in the above-mentioned case of FIG. 1, it is proposed to construct one semiconductor integrated circuit device by a plurality of chips (i.e., multi-chip semiconductor integrated circuit device).

This multi-chip semiconductor integrated circuit device composed of a plurality of chips is proposed on the assumption that this multi-chip semiconductor integrated circuit device is able to output a large voltage, i.e., so-called large amplitude voltage that the semiconductor integrated circuit device 30 comprised of single chip, for example, cannot output.

Display devices such as a liquid-crystal display device and power devices such as a motor might be a load, which requires a voltage of large amplitude, connected to the output side of the semiconductor integrated circuit device so as to be driven.

FIG. 2 shows a circuit arrangement of a semiconductor integrated circuit device composed of a plurality of chips (multi-chip semiconductor integrated circuit device). In particular, FIG. 2 shows a circuit arrangement of a plurality of chips comprising the semiconductor integrated circuit device.

In addition, FIG. 2 shows a circuit arrangement of a multi-chip semiconductor integrated circuit device, i.e., a so-called two-in-one type multi-chip semiconductor integrated circuit device 40 consisting of two chips (a first chip 401 and a second chip 402), for example.

The multi-chip semiconductor integrated circuit device 40 comprises the first chip 401 and the second chip 402 as mentioned above. Although not shown, these first and second chips 401, 402 are mounted on the same substrate, for example, and the substrate with the first and second chips 401, 402 mounted thereon is fabricated as the package to form the multi-chip semiconductor integrated circuit device 40.

The first chip 401 is adapted to generate an analog signal based upon the digital input. Also, the second chip 402 is adapted to amplify or shift in potential the analog signal inputted from the first chip 401 to output the shifted analog signal in order to obtain analog characteristics based upon the load to be driven.

The first chip 401 is comprised of a digital circuit 42, a first analog circuit 43, a communication means (serial communication means) 44, a memory means 45 and a first analog adjustment means 46 similarly to the chip 301 shown in FIG. 1.

As described above, the digital circuit 42 is adapted to process digital data inputted from the outside to output a digital signal. The first analog circuit 43 is adapted to convert the digital signal inputted from the digital circuit 42 into an analog signal by a suitable means such as a D/A (digital-to-analog) converter.

The serial adjustment means 44 is adapted to control writing of information in the memory means 45 and disconnection of the memory means 45 based on the information or the command inputted from the outside as described above. The serial adjustment means 44 is operated under control of a serial protocol such as I²C (Inter-Integrated Circuit) as described above.

Also, the memory means 45 holds information outputted from the aforementioned serial communication means 44, and outputs the information from the serial communication means 44 to the first analog adjustment means 46. The memory means 45 is composed of a zapping zener diode or a fuse-element of the type that is to be disconnected by laser beams as described above.

As described above, the analog adjustment means 46 generates a signal to adjust the first analog circuit 43 based upon the information inputted from the aforementioned memory means 45.

According to the first chip 401 having such arrangement, in the process (inspection process) for adjusting characteristics in a manufacturing process which will be described later on, the characteristics of the first analog circuit 43 are to be trimmed.

On the other hand, the second chip 402 is composed of a second analog circuit 53, a communication means (serial communication means) 54, a memory means 55, a second analog adjustment means 56 and a reference voltage/current generating means 58.

The second analog circuit 53 is adapted to amplify or shift in potential the analog signal and drive a load in order to obtain an analog signal having characteristics based on the product specification. The reference voltage/current generating means 58 is adapted to generate a reference voltage or a reference current of an analog signal outputted to the outside.

It has been customary to provide the reference voltage/current generating circuit on the chip of the output side when analog characteristics to the output side are primary characteristics.

The serial communication means 54, the memory means 55 and the second analog adjustment means 56 are similar to those of the first chip 401, and therefore need not be described in detail.

According to the second chip 402 having such arrangement, in the process (inspection process) for adjusting characteristics in the manufacturing process which will be described later on, the characteristics of the second analog circuit 53 are to be trimmed.

After the first and second chips 401, 402 having such arrangements have been separately inspected by the inspection processes, the first and second chips 401, 402 are fabricated as the package to form the multi-chip semiconductor integrated circuit device 40.

In the inspection process of the first chip 401, the characteristic of the first analog circuit 43, for example, is trimmed by the characteristic adjustment means 47 composed of the serial communication means 44, the memory means 45 and the first analog adjustment means 47 provided in the first chip 401 as described above.

In the inspection process of the second chip 402, the characteristic of the second analog circuit 53, for example, is trimmed by the characteristic adjustment means 57 composed of the serial communication means 54, the memory means 55 and the second analog adjustment means 56 provided in the second chip 402.

However, according to the above-mentioned manufacturing process, since the substrate with the first and second chips 401, 402 mounted thereon is fabricated as the package to form the multi-chip semiconductor integrated circuit device 40 after the inspection processes for carrying out such trimming treatments have been carried out separately, it was difficult to obtain highly-accurate analog characteristics as the product specification.

More specifically, when the above-mentioned substrate with the first and second chips 401, 402 mounted thereon is fabricated as the package to form the multi-chip semiconductor integrated circuit device 40 by a resin mold technology, for example, characteristics of the element used in the analog circuit are fluctuated by mold stress so that the analog characteristics of the first and second analog circuits 43, 53 are also fluctuated in the multi-chip semiconductor integrated circuit device 40 such as the above-mentioned multi-chip integrated circuit device having a complex shape.

More specifically, since the substrate with the first and second chips 401, 402 mounted thereon is fabricated as the package to form the product of the multi-chip semiconductor integrated circuit device 40 after the characteristics have been adjusted by the suitable method such as the trimming treatment as described above, if the above-mentioned substrate is fabricated as the package to form the above multi-chip semiconductor integrated circuit device 40 by using the resin mold technology, then although the characteristics are adjusted, the analog characteristics of the thus manufactured multi-chip semiconductor integrated circuit device 40 are fluctuated by mold stress in a complex fashion.

The fluctuations of the analog characteristics cannot be predicted until the semiconductor integrated circuit device is manufactured as the product. Accordingly, as described above, it has been so far difficult to obtain highly-precise analog characteristics as the product specification.

Also, in the trimming treatments at the aforementioned inspection processes, since the first and second analog circuits 43, 44 are separately trimmed by the characteristic adjustment means 47, 57 respectively provided in the first and second chips 401, 402, a time required by the trimming treatment increases, and concurrently therewith, a time required by the inspection processes also increases.

Then, when a semiconductor integrated circuit device is composed of more than three chips, for example, a time required by the trimming treatment increases much more. In this case, a time required by the inspection process also increases and a manufacturing cost of the multi-chip semiconductor integrated circuit device 40 also increases unavoidably.

In addition, since the second chip 402, in particular, is required to have a high withstand voltage on the basis of a load to be driven, it is unavoidable that the size of the element such as a transistor should increase. In such tendency, when the second chip 402 is constructed by mounting a large number of elements such as the analog adjustment means 54, the memory means 55 and the serial communication means 56 on the substrate, the area of the second chip 402 increases considerably, and hence the chip area as the multi-chip semiconductor integrated circuit device 40 also increases.

As a result, the manufacturing cost of the multi-chip semiconductor integrated circuit device 40 increases so that it becomes difficult to trim the second chip 402 with accuracy higher than that obtained when the value of the reference voltage is adjusted under the condition in which the multi-chip integrated circuit device 40 is still set in the substrate state.

### SUMMARY OF THE INVENTION

In view of the aforesaid aspect, it is an object of the present invention to provide a semiconductor integrated circuit device having a simple arrangement capable of adjusting characteristics of a plurality of chips.

It is another object of the present invention to provide a method of manufacturing a semiconductor integrated circuit device capable of making analog characteristics become high in accuracy as a product specification and which can reduce a time required by an inspection process.

According to an aspect of the present invention, there is provided a semiconductor integrated circuit device having a plurality of chips and which is fabricated as a package. This semiconductor integrated circuit device is comprised of characteristic adjustment means provided on only one chip of a plurality of chips for adjusting characteristics of a plurality of chips.

According to the above-mentioned present invention, in the semiconductor integrated circuit device having a plurality of chips mounted thereon and which is fabricated as the package, of a plurality of chips, only one portion of the chips is provided with the characteristic adjustment means for adjusting characteristics of a plurality of chips so that characteristics of other chips than one chip, which are not provided with the characteristic adjustment means, can be adjusted by the characteristic adjustment means provided in one portion of the chips.

Also, since a plurality of chips comprising the semiconductor integrated circuit device are not provided with the characteristic adjustment means except one portion of the chips, the semiconductor integrated circuit device can be simplified in arrangement.

According to another aspect of the present invention, there is provided a method of manufacturing a semiconductor integrated circuit device having a plurality of chips mounted thereon and which is fabricated as a package. This manufacturing method is comprised of a process for mounting a plurality of chips containing chips having characteristic adjustment means and chips which do not include the characteristic adjustment means and fabricating these chips as a package to form a semiconductor integrated circuit device and a process for adjusting characteristics of the chips including the characteristic adjustment means and characteristics of the chips which do not include the characteristic adjustment means by using the characteristic adjustment means.

According to the above-mentioned present invention, the method of manufacturing the semiconductor integrated circuit device having a plurality of chips and which is fabricated as the package comprises the process for mounting a plurality of chips containing the chip including the characteristic adjustment means and the chips without the characteristic adjustment means thereon to fabricate them as the package to form the semiconductor integrated circuit device and the succeeding process for adjusting the characteristics of the chip with the characteristic adjustment means and adjusting the characteristics of the chips without the characteristic adjustment means, when these chips are fabricated as the package to form the semiconductor integrated circuit device by using the resin mold technique, for example, even if the characteristics are fluctuated by the influence of mold stress and the like, these fluctuations of the characteristics can be adjusted in the succeeding processes in which the characteristics of chips are adjusted.

More specifically, regardless of the influence such as mold stress produced when the chips are fabricated as the package, highly-precise characteristics can be obtained as the semiconductor integrated circuit device formed as the product.

In addition, a time required to adjust characteristics can be reduced as compared with the case in which respective characteristics are adjusted by the characteristic adjustment means provided at every chip.

### BRIEF DESCRIPTION OF THE DRAWINGS

FIG. 1 is a schematic block diagram showing a circuit arrangement of a semiconductor integrated circuit device according to the related art;

FIG. 2 is a schematic block diagram showing a circuit arrangement of a multi-chip semiconductor integrated circuit device composed of a plurality of chips according to the related art;

FIG. 3 is a schematic block diagram showing a circuit arrangement of a multi-chip semiconductor integrated circuit device according to an embodiment of the present invention; and

FIG. 4 is a flowchart to which reference will be made in explaining a method of manufacturing a multi-chip semiconductor integrated circuit device according to an embodiment of the present invention.

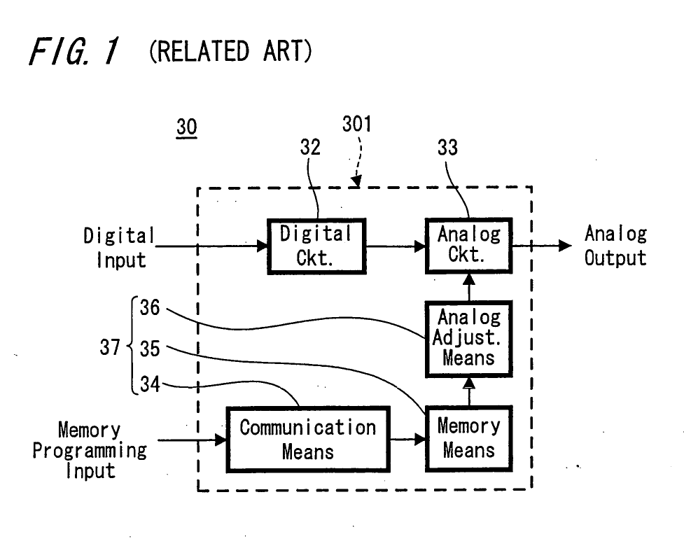

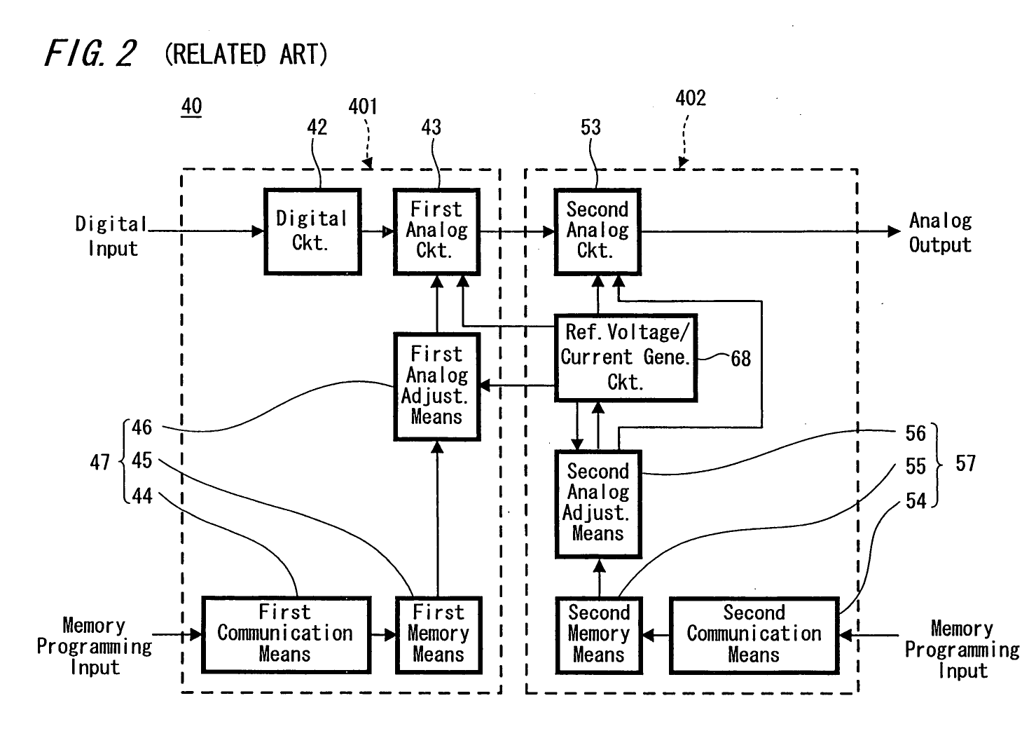

### DESCRIPTION OF THE PREFERRED EMBODIMENT

A semiconductor integrated circuit device and a method of manufacturing such a semiconductor integrated circuit device according to an embodiment of the present invention will be described below with reference to the drawings.

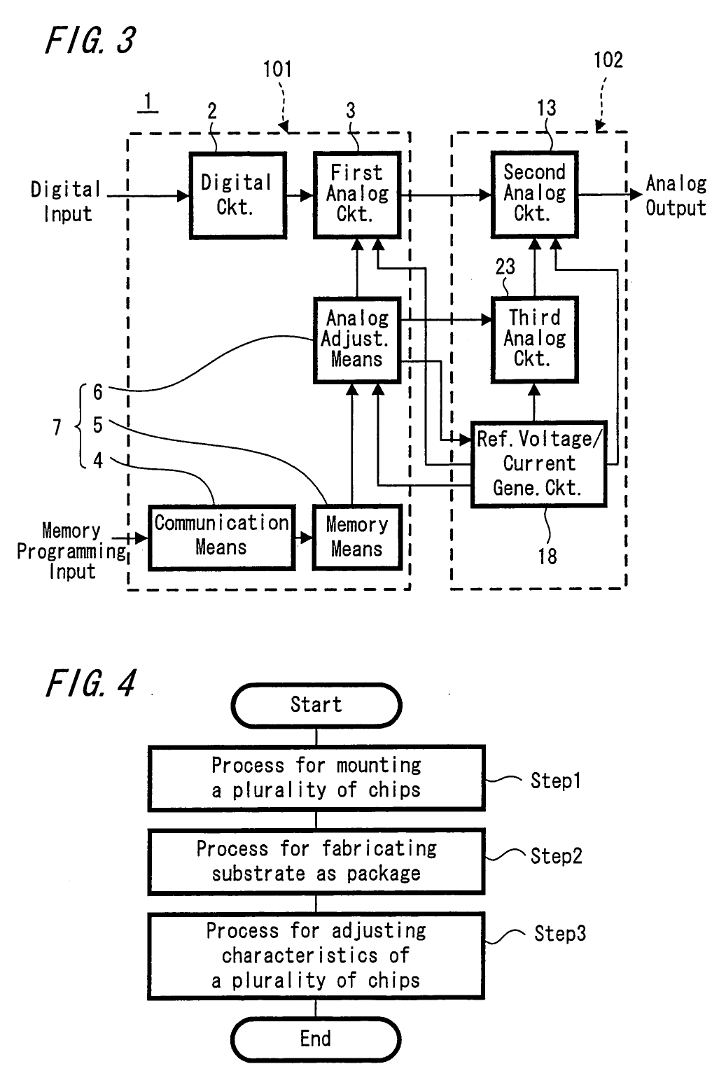

FIG. 3 shows a semiconductor integrated circuit device according to an embodiment of the present invention.

Especially, FIG. 3 shows circuit arrangements of a plurality of chips comprising a semiconductor integrated circuit device according to the present invention.

A semiconductor integrated circuit device, generally depicted by the reference numeral 1 in FIG. 3, is a semiconductor integrated circuit device composed of two chips (a first chip 101 and a second chip 102), i.e., so-called two-in-one type multi-chip semiconductor integrated circuit device 1. Although not shown, these first and second chips 101, 102 are mounted on the same substrate, for example, and the substrate with the first and second chips 101, 102 mounted thereon is fabricated as a package to form the multi-chip semiconductor integrated circuit device 1.

As shown in FIG. 3, the first chip 101 is adapted to output an analog signal based upon the digital input from the outside, and the second chip 102 is adapted to amplify or shift in potential the analog signal outputted from the first chip 101 as an analog output.

The first chip 101 is composed of a digital circuit 2 for processing digital data inputted from the outside to output a digital signal and a first analog circuit 3 for converting the digital signal inputted from the digital circuit 2 into an analog signal by a suitable means such as a D/A (digital-to-analog) converter.

In this first chip 101, the characteristic of the first analog circuit 3 is adjusted (i.e., trimmed) in the trimming treatment in the manufacturing process, which will be described later on, i.e., in the process (so-called inspection process) in which characteristics, for example, are adjusted.

On the other hand, the second chip 102 is composed of a second analog circuit 13 for amplifying or shifting in potential the analog signal inputted from the first analog circuit 3 of the first chip 101, a reference voltage/current generating circuit 18 for generating a reference voltage or a reference current of an analog output outputted to the outside and further a third analog circuit 23.

In this second chip 102, the characteristic of the second analog circuit 13 is adjusted (i.e., trimmed) in the trimming treatment executed in the manufacturing process, which will be described later on, i.e., in the process (so-called inspection process) in which characteristics, for example, are adjusted.

Then, according to this embodiment, in particular, of the first and second chips 101, 102, only the first chip 101 is provided with a so-called characteristic adjustment means 7 for adjusting characteristics of the second analog circuit 13 of the second chip 102 in addition to the characteristics of the first analog circuit 3 of the first chip 101.

More specifically, in one semiconductor integrated circuit device composed of a plurality of chips, each chip is not provided with the characteristic adjustment means 7, and according to this embodiment, only one chip is provided with the characteristic adjustment means 7.

The characteristic adjustment means 7 provided only in the first chip 101 is comprised of a communication means (serial communication means) 4, a memory means 5 and an analog circuit adjustment means 6, and trims the analog characteristic of the first analog circuit 3 of the first chip 101 and the analog characteristic of the second analog circuit 13 of the second chip 102 in the manufacturing process as described above.

The serial communication means 4 writes information in the memory means 5, which will be described later on, and controls disconnection operation of the memory means 5 based upon information (data) or a command inputted from the outside. The serial communication means 4 is operated under control of a serial protocol such as I²C (Inter-Integrated Circuit).

The memory means 5 holds the information written therein by the aforementioned serial communication means 4 or outputs the written information to the analog adjustment means 6 which will be described later on.

This memory means 5 is composed of at least a fuse-element to disconnect itself electrically, for example, and power for disconnecting the fuse-element is controlled so as to fall within an element rating in the process for manufacturing the first chip 101, for example, so that characteristics of other elements of the first chip 101, for example, may not be damaged. This memory means 5 has another function to experimentally output adjustment information without changing the state of the fuse-element.

The analog adjustment means 6 outputs a signal to adjust the characteristic of the first analog circuit 3 and the characteristic of the second analog circuit 13 based upon the information outputted from the aforementioned memory means 5.

The output generated from the characteristic adjustment means 7 (i.e., output generated from the analog circuit adjustment means 6) is used to adjust the characteristic of the first analog circuit 3 mounted on the first chip 101 and to adjust the characteristics of the third analog circuit 23 and the reference voltage/current generating means 18 mounted on the second chip 102. In that case, the analog adjustment means 6 generates an output in response to (in proportion to) the analog reference voltage/current generated from the reference voltage/current generating means 18, and the output generated from this analog adjustment means 6 is used to adjust the characteristic of the first analog circuit 3.

Also, the output generated from the analog adjustment means 6 through the first analog circuit 3 is used to adjust the characteristic of the second analog circuit 13 of the second chip 102.

According to the multi-chip semiconductor integrated circuit device 1 of this embodiment, of the first and second chips 101, 102 comprising the multi-chip semiconductor integrated circuit device 1, since only the first chip 101 is provided with the characteristic adjusting means 7 for adjusting a characteristic of the first analog circuit 3 provided in the first chip 101, a characteristic of the second analog circuit 13 provided in the second chip 102, a characteristic of the third analog circuit 23 and a characteristic of the reference voltage/current generating means 18, the second chip 102 can be simplified in arrangement as compared with the semiconductor integrated circuit device in which each of the first and second chips is provided with the characteristic adjustment means.

Although it is unavoidable that the second chip 102 increases its element size because it is required to have a high withstand voltage, the characteristic adjustment means is removed from the second chip 102 so that the second chip 102 can be simplified in arrangement, the second chip 102 being reduced in area.

Accordingly, it is possible to reduce the area of the semiconductor integrated circuit device.

While the digital circuit 2 is mounted on the first chip 101 in the multi-chip semiconductor integrated circuit device 1 according to the above-mentioned embodiment, the digital circuit 2 need not always be mounted on the first chip 101.

While the third analog circuit 23 is mounted on the second chip 102 in addition to the second analog circuit 13 as described above, the third analog circuit 23 need not always be mounted on the second chip 102.

Next, a method of manufacturing a semiconductor integrated circuit device according to an embodiment of the present invention will be described below with reference to a flowchart of FIG. 4.

In this embodiment, let us describe the case in which the multi-chip semiconductor integrated circuit device 1 comprised of the chips 101, 102 having the arrangements shown in FIG. 3 is to be manufactured.

In the case of FIG. 4, let us start describing this manufacturing method from the stage in which the chip (first chip 101) with the characteristic adjustment means 7 and the chip (second chip 102) without the characteristic adjustment means 7 have already been formed.

Referring to FIG. 4, and following the start of operation, first, at a step 1, the first chip 101 with the characteristic adjustment means 7 and the second chip 102 without the characteristic adjustment means 7 are mounted on the same substrate, for example.

The first and second chips 101, 102 have already been inspected in a range in which they can be trimmed in the inspection process such as a trimming treatment for adjusting characteristics, which will be described later on. In other words, in the inspection process which will be described later on, only the chip that should be trimmed is mounted on the substrate.

As shown in FIG. 4, at the next step 2, the substrate on which the first and second chips 101, 102 were mounted is fabricated as a package to form the multi-chip semiconductor integrated circuit device 1.

More specifically, the substrate with the first and second chips 101, 102 mounted thereon is attached to a lead frame of the package by chip bonding, for example. Then, after the electrodes of the first and second chips 101, 102 have been interconnected to lead wires by wire bonding, the substrate is fabricated as a package by a resin mold technology, for example, to form the multi-chip semiconductor integrated circuit device 1.

Then, according to this embodiment, in particular, after the semiconductor integrated circuit device 1 has been formed as the product as described above, control goes to a step 3, whereat an inspection process such as a trimming treatment for adjusting characteristics is carried out.

More specifically, as described above, in the first and second chips 101, 102 comprising the multi-chip semiconductor integrated circuit device 1, the first and second analog circuits 3, 13 that are to be trimmed are trimmed (fine adjusted) by the trimming treatment.

In that case, according to this embodiment, the first analog circuit 3 of the first chip 101 and the second analog circuit 13 of the second chip 102 are trimmed by using the characteristic adjustment means 7 composed of the serial communication means 4, the memory means 5 and the analog adjustment means 6.

To be more concrete, in the characteristic adjustment means 7 provided only in the first chip 101, adjustment information (memory programming data) is inputted through the serial communication means 4 and the memory means 5 to the analog adjustment means 6 based upon the digital data inputted from the outside to the first chip 101 such that an error of the analog output from the second chip 102 may fall within a desired value. After that, if adjustment information is determined, then the trimming treatment such as disconnecting a corresponding fuse-element is carried out, and information is written in the memory means 5.

The output generated from the analog adjustment means 6 based upon the adjustment information inputted to the analog adjustment means 6 is used to adjust the characteristic of the first analog circuit 3 mounted on the first chip 101 and is also used to adjust the characteristic of the third analog circuit 23 and the characteristic of the reference voltage/current generating means 18 mounted on the second chip 102. In that case, the analog adjustment means 6 generates an output in response to (in proportion to) the analog reference voltage generated from the reference voltage/current generating means 18, and the output generated from this analog adjustment means 6 is used to trim the first analog circuit 3.

In addition, the output generated from the analog adjustment means 6 is used to trim the second analog circuit 13 on the second chip 102 through the first analog circuit 3.

The reason that the characteristic adjustment 7 provided only in the first chip 101 can trim the second analog circuit 13 provided on the second chip 102 at the same time it can trim the first analog circuit 3 of the first chip 101 is that, unlike the first analog circuit 3 having a function to generate the analog signal, the second analog circuit 13 has a function to amplify or shift in potential the output from the first analog circuit 3 so that, of the characteristics of the second analog circuit 13, an error that should be adjusted (error that should be trimmed) can be converted into an error of the first analog circuit 3. Accordingly, it is sufficient that the multi-chip semiconductor integrated circuit device 1 may be designed such that a range of error adjusted by the second analog circuit 13 can include a total amount of an error of the first analog circuit 3 and an error of the second analog circuit 13.

After the trimming treatments of the first and second analog circuits 3, 13 provided in the first and second chips 101 and 102 have been completed, the inspection process is ended.

Thereafter, the multi-chip semiconductor integrated circuit device 1 will be further tested by a suitable test such as a characteristic test.

According to the above-mentioned semiconductor integrated circuit device manufacturing method of this embodiment, since the first and second analog circuits 3, 13 provided on the first and second chips 101, 102 are trimmed after the substrate with the first and second chips 101, 102 mounted thereon has been fabricated as the package to form the multi-chip semiconductor integrated circuit device 1 as the product, when the resin mold technique, for example, is used in the process in which the above substrate is fabricated as the package to form the multi-chip semiconductor integrated circuit device 1, even if the characteristics are fluctuated by the influence such as mold stress, the fluctuations of these characteristics can be adjusted in the succeeding process, i.e., in the process for adjusting the characteristics.

In other words, regardless of the influence such as the mold stress produced when the substrate is fabricated as the package, highly-precise characteristics can be obtained as the semiconductor integrated circuit device formed as the product.

Also, since the analog characteristic of the first analog circuit 3 on the first chip 101 and the analog characteristic of the second analog circuit 13 on the second chip 102 are trimmed by the characteristic adjustment means 7 provided only in the first chip 101, a time required by the trimming treatment can be reduced as compared with the case in which the trimming treatment is carried out at each of the first and second chips.

Since a time required by the trimming treatment can be reduced as described above, a time required by the inspection process for carrying out the trimming treatment also can be reduced.

When the semiconductor integrated circuit device is composed of a large number of chips, for example, a time required by the trimming treatment can be reduced considerably so that a time required by the inspection process also can be reduced considerably.

While the multi-chip semiconductor integrated circuit device 1 having the arrangement in which digital data is inputted to the first chip 101 from the outside and analog data is outputted from the second chip 102 has been described so far in the above-mentioned embodiment, the present invention is not limited thereto, and the multi-chip semiconductor integrated circuit device 1 having the above arrangement can be modified as a semiconductor integrated circuit device having an arrangement in which analog data is inputted to the second chip 102 from the outside and digital data is outputted from the first chip 101.

While the semiconductor integrated circuit device composed of the two chips has been described so far in the above-mentioned embodiment, the present invention is not limited thereto, and the number of chips comprising the semiconductor integrated circuit device is not limited to two and may be more than three. In addition, when a semiconductor integrated circuit device is composed of a large number of chips, some chip (a plurality of chips may be possible) may be provided with the characteristic adjustment means.

According to the semiconductor integrated circuit device of the present invention, since only some chip of a plurality of chips is provided with the characteristic adjustment means, the semiconductor integrated circuit device can be simplified in arrangement as compared with the case in which each chip is provided with the characteristic adjustment means. Consequently, it is possible to obtain the semiconductor integrated circuit device that can be reduced in size.

In particular, since the chip of which each element size is increased by the requirements of a high-withstand voltage can remove the characteristic adjustment means, it can reduce the chip area.

Also, according to the semiconductor integrated circuit device manufacturing method of the present invention, even when the characteristic is fluctuated by the influence such as the mold stress, the highly-precise characteristic can be obtained as the product of the semiconductor integrated circuit device regardless of the influence such as the mold stress.

Further, a time required by the process for adjusting characteristics can be reduced as compared with the case in which characteristic is adjusted at every chip, for example. As a result, a time required to manufacture a semiconductor integrated circuit device also can be reduced.

Furthermore, when the semiconductor integrated circuit device is composed of a large number of chips, for example, a time required to adjust characteristics can be reduced considerably. Accordingly, it is possible to considerably reduce a time required to manufacture a semiconductor integrated circuit device.

Having described a preferred embodiment of the invention with reference to the accompanying drawings, it is to be understood that the invention is not limited to that precise embodiment and that various changes and modifications could be effected therein by one skilled in the art without departing from the spirit or scope of the invention as defined in the appended claims.

What is claimed is:

1. A semiconductor integrated circuit device having a plurality of chips and which is fabricated as a package, comprising:
characteristic adjustment means provided on only one chip of said plurality of chips for adjusting characteristics of said plurality of chips.

2. A semiconductor integrated circuit device according to claim 1, wherein said characteristic adjustment means is comprised of communication means, memory means and adjustment means, said communication means controls said memory means based on information inputted from the outside, said memory means holds said information inputted from said communication means and outputs said information to said adjustment means and said adjustment means outputs a signal to adjust characteristics based upon said information outputted from said memory means.

3. A semiconductor integrated circuit device according to claim 2, wherein said memory means is composed of at least a fuse-element.

4. A method of manufacturing a semiconductor integrated circuit device having a plurality of chips mounted thereon and which is fabricated as a package, comprising the steps of:
a process for mounting a plurality of chips containing chips having characteristic adjustment means and chips which do not include said characteristic adjustment means and fabricating these chips as a package to form a semiconductor integrated circuit device; and
a process for adjusting characteristics of the chips including said characteristic adjustment means and characteristics of the chips which do not include said characteristic adjustment means by using said characteristic adjustment means.

5. A method of manufacturing a semiconductor integrated circuit device according to claim 4, wherein said characteristic adjustment means is composed of communication means, memory means and adjustment means, said communication means controls said memory means based upon information inputted from the outside, said memory means holds said information inputted from said communication means and outputs said information to said adjustment means and said adjustment means outputs a signal to adjust characteristics based upon said information outputted from said memory means.

6. A method of manufacturing a semiconductor integrated circuit device according to claim 5, wherein said memory means is composed of at least a fuse-element.
